(19) United States
(12) Patent Application Publication
(10) Pub. No.: US 2012/0255839 A1
(43) Pub. Date: Oct. 11, 2012

(54) ARRANGEMENT HAVING A SWITCH, IN PARTICULAR HAVING A LOW-VOLTAGE CIRCUIT-BREAKER

(75) Inventor: Steffen Grasnick, Furstenwalde (DE)

(73) Assignee: SIEMENS AKTIENGESELLSCHAFT, Munich (DE)

(21) Appl. No.: 13/440,449

(22) Filed: Apr. 5, 2012

(30) Foreign Application Priority Data
Apr. 6, 2011 (DE) 10 2011 006 830.9

(51) Int. Cl. H02B 11/02

(52) U.S. Cl. 200/50.27

(57) ABSTRACT

An arrangement includes a switch, including main contacts for connection, the switch being insertable into a mounting rack as far as a final position in which the main contacts make contact with power connections arranged on the mounting rack. Auxiliary contacts, arranged on the mounting rack and on the switch, are designed to correspond to one another and make electrical contact with one another when the switch is inserted. In an embodiment, the auxiliary contacts on the rack are contact pins, and the auxiliary contacts on the switch are sockets, or vice versa, the contact pins being moved into the sockets beyond a movement distance from the final position during insertion of the switch and remaining in electrical contact until the final position of the switch, and the main contacts making contact with the power connections once after the final position has been reached.

### PRIORITY STATEMENT

The present application hereby claims priority under 35 U.S.C. §119 to German patent application number DE 10 2011 006 830.9 filed Apr. 6, 2011, the entire contents of which are hereby incorporated herein by reference.

### FIELD

At least one embodiment of the invention generally relates to an arrangement having a switch, in particular having a circuit breaker for low voltages.

### BACKGROUND

Circuit breakers for low voltages are known and are used for protection of switchgear assemblies, in particular against overcurrents and short-circuit currents. For this purpose, they have switching contacts which are disconnected from one another by means of a switching mechanism in order to open the circuit breaker. Current transformers are provided in order to detect the current flowing through the switch. An electronic tripping unit compares the detected current with a predetermined threshold value, and initiates disconnection of the switching contacts when the threshold value is exceeded.

The circuit breakers may be in the form of withdrawable switches which are pushed into a mounting rack. Power connections attached to busbars are located in the rear area on the mounting rack. When the inserted final position is reached (operating position) these power connections make contact with main contacts of the circuit breaker, which are located on the rear side of the circuit breaker. In addition to the power connections, electrical auxiliary contacts are arranged in the front area of the mounting rack and correspond with auxiliary contacts (plugs, sockets) which are arranged on the circuit breaker. When the circuit breaker is being inserted from the disconnected position into the operating position, the auxiliary contacts make contact with one another first of all, beyond a movement distance, in order, in particular, to allow electrical signals to be transmitted from the circuit breaker to the mounting rack, and vice versa, in particular for purposes of testing the tripping unit, without the main contacts having already been connected to the power connections.

Sliding contact systems having at least one flat sliding contact, whose mating contact is formed from contact springs, are often used for the auxiliary contacts. During insertion of the circuit breaker, the contact springs slide along one or both sides of the sliding contact. They should slide on both sides, for reliable contact. This has the disadvantage that, when there is a relatively large number of contacts, a relatively large installation space is required, which means that contacts can in practice be arranged only in a duplicated form one above the other.

Alternatively, plug-in contact systems are also used, in which the auxiliary contacts are in the form of plugs and sockets. The connected plugs and sockets are pushed together until the final inserted position is reached, after contact has been made. This has the disadvantage that the connecting cables have to compensate for the movement, on at least one contact side.

### SUMMARY

At least one embodiment of the invention provides that the auxiliary contacts on the rack are in the form of pins, and the auxiliary contacts on the switch are in the form of sockets, and vice versa, with the pins being moved into the sockets beyond a predetermined movement distance during insertion of the switch, and remaining in electrical contact until the final position of the switch, and that the main contacts (after passing through the movement distance) make contact with the power connections only once the final position has been reached, that is to say only in the region of the final position. The connecting cables can therefore be laid fixed on both contact sides and a multiplicity of contacts can also be arranged one above the other, limited only by the air gaps and creepage distances present. The signals are transmitted without interruption from the initial contact until movement distance to the final inserted position of the switch, that is to say the operating position. During the process, the pins slide through the associated sockets. In other words: the plug contact slides through the socket contact.

It is advantageously proposed that the auxiliary contacts are arranged on a plurality of levels.

In order to identify the respective position of the switch along the insertion movement, it is proposed that the pins additionally have different lengths.

### BRIEF DESCRIPTION OF THE DRAWINGS

The invention will be described in more detail in the following text with reference to one example embodiment. In the figures:

FIG. 1 shows a detail of a switch with a mounting rack in the disconnected position,

FIG. 2 shows auxiliary contacts on the rack and on the switch as shown in FIG. 1, in the disconnected position,

FIG. 3 shows the auxiliary contacts on the rack and on the switch as shown in FIG. 1, in the test position,

FIG. 4 shows the auxiliary contacts on the rack and on the switch as shown in FIG. 1, in the operating position, and

FIG. 5 shows the auxiliary contacts as shown in FIG. 2, with different lengths.

It should be noted that these Figures are intended to illustrate the general characteristics of methods, structure and/or materials utilized in certain example embodiments and to supplement the written description provided below. These drawings are not, however, to scale and may not precisely reflect the precise structural or performance characteristics of any given embodiment, and should not be interpreted as defining or limiting the range of values or properties encompassed by example embodiments. The use of similar or identical reference numbers in the various drawings is intended to indicate the presence of a similar or identical element or feature.

### DETAILED DESCRIPTION OF THE EXAMPLE EMBODIMENTS

Various example embodiments will now be described more fully with reference to the accompanying drawings in which only some example embodiments are shown. Specific structural and functional details disclosed herein are merely representative for purposes of describing example embodiments. The present invention, however, may be embodied in many alternate forms and should not be construed as limited to only the example embodiments set forth herein.

Accordingly, while example embodiments of the invention are capable of various modifications and alternative forms, embodiments thereof are shown by way of example in the drawings and will herein be described in detail. It should be understood, however, that there is no intent to limit example embodiments of the present invention to the particular forms disclosed. On the contrary, example embodiments are to cover all modifications, equivalents, and alternatives falling within the scope of the invention. Like numbers refer to like elements throughout the description of the figures.

Before discussing example embodiments in more detail, it is noted that some example embodiments are described as processes or methods depicted as flowcharts. Although the flowcharts describe the operations as sequential processes, many of the operations may be performed in parallel, concurrently or simultaneously. In addition, the order of operations may be re-arranged. The processes may be terminated when their operations are completed, but may also have additional steps not included in the figure. The processes may correspond to methods, functions, procedures, subroutines, subprograms, etc.

Methods discussed below, some of which are illustrated by the flow charts, may be implemented by hardware, software, firmware, middleware, microcode, hardware description languages, or any combination thereof. When implemented in software, firmware, middleware or microcode, the program code or code segments to perform the necessary tasks will be stored in a machine or computer readable medium such as a storage medium or non-transitory computer readable medium. A processor(s) will perform the necessary tasks.

Specific structural and functional details disclosed herein are merely representative for purposes of describing example embodiments of the present invention. This invention may, however, be embodied in many alternate forms and should not be construed as limited to only the embodiments set forth herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments of the present invention. As used herein, the term “and/or,” includes any and all combinations of one or more of the associated listed items.

It will be understood that when an element is referred to as being “connected,” or “coupled,” to another element, it can be directly connected or coupled to the other element or intervening elements may be present. In contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting of example embodiments of the invention. As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Portions of the example embodiments and corresponding detailed description may be presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

In the following description, illustrative embodiments may be described with reference to acts and symbolic representations of operations (e.g., in the form of flowcharts) that may be implemented as program modules or functional processes include routines, programs, objects, components, data structures, etc., that perform particular tasks or implement particular abstract data types and may be implemented using existing hardware at existing network elements. Such existing hardware may include one or more Central Processing Units (CPUs), digital signal processors (DSPs), application-specific-integrated-circuits, field programmable gate arrays (FPGAs) computers or the like.

Note also that the software implemented aspects of the example embodiments may be typically encoded on some form of program storage medium or implemented over some type of transmission medium. The program storage medium (e.g., non-transitory storage medium) may be magnetic (e.g., a floppy disk or a hard drive) or optical (e.g., a compact disk read only memory, or “CD ROM”), and may be read only or random access. Similarly, the transmission medium may be twisted wire pairs, coaxial cable, optical fiber, or some other suitable transmission medium known to the art. The example embodiments not limited by these aspects of any given implementation.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” of “displaying” or the like, refer to the action and processes of a computer system, or similar electronic computing device/hardware, that manipulates and transforms data represented as physical, electronic quantities within the computer system's registers and memories into other data similarly represented as physical quantities within the computer system memories or registers or other such information storage, transmission or display devices.

Spatially relative terms, such as “beneath”, “below”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, term such as “below” can encompass both an orientation of above and below. The device may be otherwise oriented (rotated 90 degrees or at other orientations) and the spatially relative descriptors used herein are interpreted accordingly.

Although the terms first, second, etc. may be used herein to describe various elements, components, regions, layers and/or sections, it should be understood that these elements, components, regions, layers and/or sections should not be limited by these terms. These terms are used only to distinguish one element, component, region, layer, or section from another region, layer, or section. Thus, a first element, component, region, layer, or section discussed below could be termed a second element, component, region, layer, or section without departing from the teachings of the present invention.

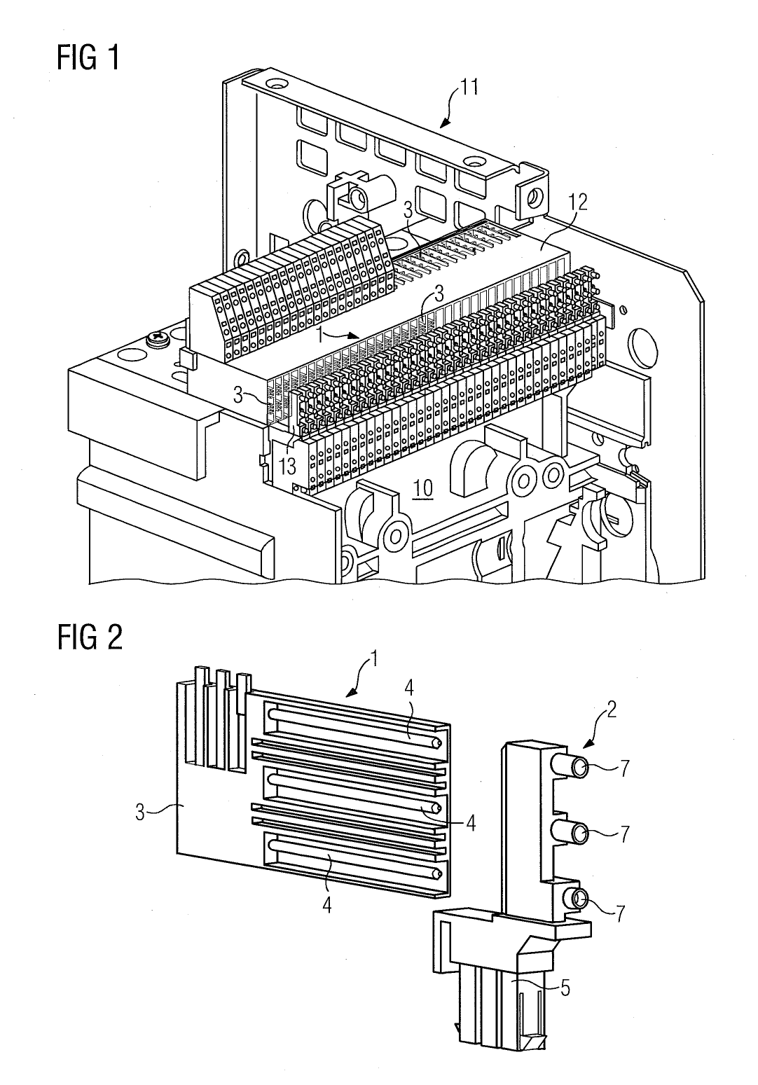

FIG. 1 shows a detail of a switch 10 which is in the form of a withdrawable circuit breaker for low voltages and can be inserted into a mounting rack 11. Current transformers are provided in order to detect the current flowing through the switch 10. An electronic tripping unit compares the detected current with a predetermined threshold value, and initiates the opening of the switch 10 when the threshold value is exceeded. In order to open the switch 10, its switching contacts are disconnected from one another by a switching mechanism.

When being installed from a disconnected position into an operating position, the switch 10 is pushed into the mounting rack 11, and is shown in the disconnected position in FIG. 1. Power connections (which cannot be seen), which are attached to busbars are located in the rear area of the mounting rack 11. Main contacts (which cannot be seen) are located on the rear side of the switch 10 and make contact with the power connections on reaching the operating position (the final inserted position) in the mounting rack 11.

Furthermore, FIG. 1 shows a multiplicity of auxiliary contacts 1, which are arranged fixed to the rack and are located on contact mounts 3, which are attached to a plug module 12 in the front area of the mounting rack 11. A socket module 13 is arranged on the switch 10, opposite the plug module 12.

In order to make the illustration clearer, FIG. 2 shows the auxiliary contacts 1 and the auxiliary contacts 2 which are arranged fixed to the switch 10, without the mounting rack 11 and the switch 10.

The auxiliary contacts 1 are arranged on the contact mount 3 as three contact pins 4 which run parallel to one another in the insertion direction and whose free ends face the insertion opening. Opposite the free ends of the contact pins 4 there is a contact mount 6, the socket mount 5, on which the auxiliary contacts 2 are located in the form of sockets 7. The socket mount 5 is arranged fixed to the switch 10 (see FIG. 1) and is pushed together with it into the mounting rack 11.

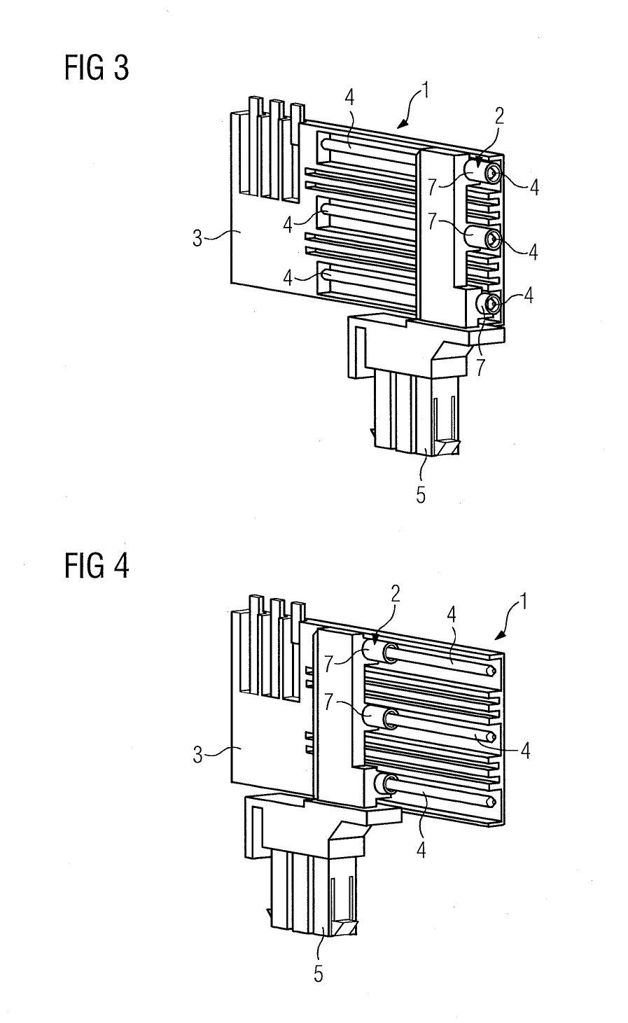

FIG. 3 shows the switch 10 having been inserted as far as a predetermined movement distance. In this insertion position, all three contact pins 4 have already been pushed into the associated socket 7, and have made an electrical contact. The electrical contact is maintained as far as the (switch) final position during the course of the movement (insertion).

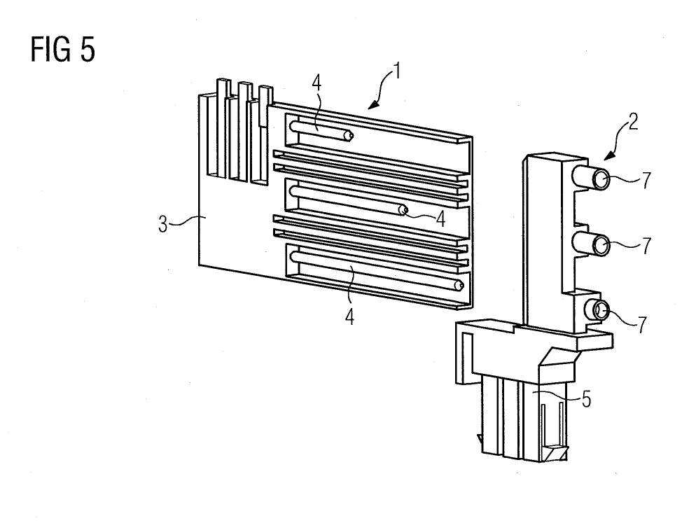

FIG. 4 shows the switch 10 in the final position, in which the socket mount 4 has been pushed on completely. The final position corresponds to the operating position, in which the main contacts of the switch 10 make contact with the power connections.

The test position is located between the switch positions shown in FIGS. 3 and 4 (including the switch position in FIG. 3), with in particular the operation of the electrical tripping unit being tested in the test position, without the switch 10 already having been connected to the switchgear assembly via the power connections of the busbars.

In order to identify the respective switch position during insertion, the pins 4 may additionally have different lengths, as is shown in FIG. 5, as a result of which they make contact with the sockets during insertion successively in time.

The patent claims filed with the application are formulation proposals without prejudice for obtaining more extensive patent protection. The applicant reserves the right to claim even further combinations of features previously disclosed only in the description and/or drawings.

The example embodiment or each example embodiment should not be understood as a restriction of the invention. Rather, numerous variations and modifications are possible in the context of the present disclosure, in particular those variants and combinations which can be inferred by the person skilled in the art with regard to achieving the object for example by combination or modification of individual features or elements or method steps that are described in connection with the general or specific part of the description and are contained in the claims and/or the drawings, and, by way of combinable features, lead to a new subject matter or to new method steps or sequences of method steps, including insofar as they concern production, testing and operating methods.

References back that are used in dependent claims indicate the further embodiment of the subject matter of the main claim by way of the features of the respective dependent claim; they should not be understood as dispensing with obtaining independent protection of the subject matter for the combinations of features in the referred-back dependent claims.

Furthermore, with regard to interpreting the claims, where a feature is concretized in more specific detail in a subordinate claim, it should be assumed that such a restriction is not present in the respective preceding claims.

Since the subject matter of the dependent claims in relation to the prior art on the priority date may form separate and independent inventions, the applicant reserves the right to make them the subject matter of independent claims or divisional declarations. They may furthermore also contain independent inventions which have a configuration that is independent of the subject matters of the preceding dependent claims.

Further, elements and/or features of different example embodiments may be combined with each other and/or substituted for each other within the scope of this disclosure and appended claims.

Still further, any one of the above-described and other example features of the present invention may be embodied in the form of an apparatus, method, system, computer program, tangible computer readable medium and tangible computer program product. For example, of the aforementioned methods may be embodied in the form of a system or device, including, but not limited to, any of the structure for performing the methodology illustrated in the drawings.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. An arrangement comprising:
a switch, including
main contacts for connection, the main contacts being insertable into a mounting rack as far as a final position in which the main contacts make contact with power connections arranged on the mounting rack, and
auxiliary contacts arranged on the switch, the mounting rack also including auxiliary contacts designed to correspond to the auxiliary contacts arranged on the switch and designed to make electrical contact with one another when the switch is inserted into the mounting rack, the auxiliary contacts on one of the mounting rack and the switch being in the form of contact pins and the auxiliary contacts on the other of the mounting rack and the switch being in the form of sockets, the contact pins being moved into the sockets beyond a movement distance from the final position during insertion of the switch into the mounting rack and remaining in electrical contact until the final position of the switch, the main contacts making contact with the power connections only once the final position has been reached.

2. The arrangement of claim 1, wherein the auxiliary contacts are arranged on a plurality of levels.

3. The arrangement of claim 1, wherein the contact pins have different lengths, in order to identify the respective switch position.

4. The arrangement of claim 2, wherein the contact pins have different lengths, in order to identify the respective switch position.

5. The arrangement of claim 1, wherein the switch is a low-voltage circuit breaker.

6. An arrangement comprising:
a mounting rack; and
a switch, the switch including
main contacts for connection, the main contacts being insertable into the mounting rack as far as a final position in which the main contacts make contact with power connections arranged on the mounting rack, and
auxiliary contacts arranged on the switch, the mounting rack also including auxiliary contacts designed to correspond to the auxiliary contacts arranged on the switch and designed to make electrical contact with one another when the switch is inserted into the mounting rack, the auxiliary contacts on one of the mounting rack and the switch being in the form of contact pins and the auxiliary contacts on the other of the mounting rack and the switch being in the form of sockets, the contact pins being moved into the sockets beyond a movement distance from the final position during insertion of the switch into the mounting rack and remaining in electrical contact until the final position of the switch, the main contacts making contact with the power connections only once the final position has been reached.

7. The arrangement of claim 6, wherein the auxiliary contacts are arranged on a plurality of levels.

8. The arrangement of claim 6, wherein the contact pins have different lengths, in order to identify the respective switch position.

9. The arrangement of claim 7, wherein the contact pins have different lengths, in order to identify the respective switch position.

10. The arrangement of claim 6, wherein the switch is a low-voltage circuit breaker.

11. A switch, comprising:
main contacts for connection, the main contacts being insertable into a mounting rack as far as a final position in which the main contacts make contact with power connections arranged on the mounting rack, and
auxiliary contacts arranged on the switch, the mounting rack also including auxiliary contacts designed to correspond to the auxiliary contacts arranged on the switch and designed to make electrical contact with one another when the switch is inserted into the mounting rack, the auxiliary contacts on one of the mounting rack and the switch being in the form of contact pins and the auxiliary contacts on the other of the mounting rack and the switch being in the form of sockets, the contact pins being moved into the sockets beyond a movement distance from the final position during insertion of the switch into the mounting rack and remaining in electrical contact until the final position of the switch, the main contacts making contact with the power connections only once the final position has been reached.

12. The switch of claim 11, wherein the auxiliary contacts are arranged on a plurality of levels.

13. The switch of claim 11, wherein the contact pins have different lengths, in order to identify the respective switch position.

14. The switch of claim 12, wherein the contact pins have different lengths, in order to identify the respective switch position.

15. The switch of claim 11, wherein the switch is a low-voltage circuit breaker.
